(19) United States
(12) Patent Application Publication
(10) Pub. No.: US 2025/0260688 A1
(43) Pub. Date: Aug. 14, 2025

(54) Online Authentication Technology

(71) Applicant: Hiroshi WATANABE, Kanagawa (JP)

(72) Inventor: Hiroshi WATANABE, Kanagawa (JP)

(21) Appl. No.: 18/857,712

(22) PCT Filed: May 10, 2023
(86) PCT No.: PCT/JP2023/017491

§ 371 Date: Oct. 17, 2024

(30) Foreign Application Priority Data
May 13, 2022 (JP) 2022-079117

(51) Int. Cl. H04L 9/40

(52) U.S. Cl. CPC H04L 63/0869; H04L 63/0838; H04L 63/0876

(57) ABSTRACT

With the conventional two-factor authentication, the security can be reinforced but the user convenience is suppressed. If additionally adopting a smart card, the user convenience is further suppressed. Many users are familiar with using passwords, and the implementation of smart cards has not spread. If only stealing a password, various net-crimes become possible. Furthermore, it is well-known that even two-factor authentication cannot avoid the theft of passwords by phishing. These problems arise from the fact that a password is exposed on the internet in the conventional online authentication and the assumption that the conventional authentication test is unidirectional from a server to a communication terminal. In the present invention, the password exchange is limited only between a regular user and a regular communication terminal and a mutual authentication technology is proposed, in which a communication terminal also tests the authentication of a server.

### FIELD OF THE INVENTION

The present invention is related to technology of system protocol to realize an online authentication method to prohibit phishing scam using a mutual test of online authentication between a server and a communication terminal without transferring the authentication information to the server and with realizing both the user convenience and the security.

### DESCRIPTION OF RELATED ART

The conventional online authentication is a constructure (system protocol of user authentication) to permit only a regular user which has been approved by a server access to the server. That is, in this system protocol, a server to which a user wants to access is the subject of the authentication test. The authentication of a user or a communication terminal which the user uses is only tested. That is, it is unidirectional authentication.

In concrete, a communication terminal in user's hand is connected to a server via some communication line wired or wireless. The said communication line constitutes a part of the internet (or network). If a user requests an access permission to a server by inputting user account information (user ID, etc.) via a communication terminal, then the server requests the user input an authentication information such as passwords (simply password hereinafter) via the communication terminal. The user inputs a password on the communication terminal and then the communication terminal transfers the password to the server. The server compares the received password with account information such as user ID (simply user ID hereinafter). If the user ID and the password are correct, then the server permits the said user access to the server. Here, “the user ID and the password are correct” means that the input user ID and that stored in the server are matched and, further, the password input for the said user ID and that stored in the server are matched.

A communication terminal is a physical existence. However, the number of communication terminals can be plural. A user can use any of the communication terminals to request access permission to a server which the user wants to access in a similar way of using the user ID and the password. That is, though the server may record the IP address or the MAC address of the communication terminal that the user used to request the access together with timestamp, the server basically permits the user to access the server only if the user ID and the password are correct.

However, this is based on the concept of the early period of the internet that there is a server in an adjoining room and hence the user can physically check the position of the server and the LAN connection. That is, it is for permitting only related persons to access the server in the situation that there are outsiders and related persons in the building.

In the present time that the WiFi and the internet have spread, a user does not know where a server to which the user tries to access is physically located. In most cases, none wants to know it. Furthermore, not only the user but also the server's administrator does not know how the connection between the server and the communication terminal in the user's hand is physically. In most cases, none wants to know it. In other words, in modern society, the convenience has been embodied, wherein an arbitral user can basically always access an arbitral server physically existing at an arbitral location on the earth only using wired or wireless internet connection (generally network) if the user has the user ID and the password

The internet has been spread thanks to this convenience. Hence, numberless accounts of individuals and corporate bodies (which are identified by user ID, etc.) try to access plural servers everyday. In this process, numberless user IDs and passwords are exposed on the internet. In the current situation, it is unknown where who manages numberless user IDs and passwords, which have been exposed like this.

### (Smartcard)

To measure this problem, there is a method to use an external device like a smart card, etc. (an additional security device other than communication terminals).

However, a smart card cannot function without a card reader. That is, the user must separately prepare both a smart card and a card reader other than a communication terminal. In the present times that majority of the internet has moved to the mobile, many users use the internet to access a targeted server from the external of their offices. In this event, the user must carry a smart card and card reader every day. Or he must always look for a location with an effective card reader (satisfying a standard). Furthermore, a user to deal with plural accounts might need to carry plural smart cards. If the standards of smart cards are different, then the standards of card readers are also different. Even with the same standard, if a security problem is found, then both smart card and card reader must be version up. Even though a user himself manages a smart card, in the case that he uses a card reader in the external of his office or house and out of his management, there is no assurance that the smart card, the card reader and the communication terminal are always managed in a consistent manner.

Hence, smart cards are left in houses or offices. Hence, the version of the card readers deserted from periodical management and usage is going to be old. Thanks to such an inconvenience, those other than some users in charge of a labor of high security avoid using the smart card. If the services assuming smart card dwindles by this way, then many servers may not adopt the authentication assuming smart card, or not upgrade.

Contemporary people got used to carrying credit cards long ago. It is a status that has been built up after the card readers of credit cards were spread in many shops. The inconvenience of smartcards is attributed mainly to the fact that specified card readers have not been spread. Hence, the users are forced to carry or manage card readers by themselves to use.

### (Two Factor Authentication)

As a compromise to control such an inconvenience, the two-factor authentication was launched.

In concrete, a communication device in user's hand is connected to a server in some communication line wired or wireless. The said communication line constitutes a part of the internet. If a user requests an access permission to a server by inputting user account information (user ID, etc.) via a communication terminal, then the server requests the user input an authentication information such as passwords (simply password hereinafter) via the communication terminal for the authentication test. The user inputs a password on the communication terminal and then the communication terminal transfers the password to the server. The server further requests the user inputs a second authentication code (Authenticator) on the communication terminal. The user can retrieve this authentication code from some external device. Here, the authentication test means that the input user ID and that stored in the server are matched and, further, the password input for the said user ID and that stored in the server are matched, and furthermore, the second authentication code input for the said user ID and that stored in the server are matched. In the case that all are matched in the test result, access is permitted.

Contemporary people got used to carrying and using smart phones, which is different from smart cards. It has not been unusual to download an application for authenticator (authentication application) and then install it on a smart phone. The authenticator shows specified digits (for example, 6-digits) of number (the second authentication code) on the display of the smart phone. That is, a smart phone with the authentication application being installed can be an external device from which the user can retrieve the second authentication code. Note a point that users have carried this external device with no feeling additional inconvenience. It may be good enough to install the authentication application once. After installing it, it is unnecessary to carry any additional security device. In this point, we can say that the convenience is not damaged.

The second authentication code is automatically updated for a predetermined expiration (for example 3 minutes). By scanning the two-dimensional code that a server displays on a communication terminal with the authentication application that have been installed into a smart phone, then the second authentication code that the authentication application displays become synchronized with an inner data of the server. That is, the user may input this second authentication code displayed on the smart phone within this authentication expiration time on the communication terminal according to the guidance provided by the server. The server may compare the input user ID, password and second authentication code with those having been stored in advance, respectively, and then determine if permitting the said user to access. By this way, the second authentication code is also exposed on the internet in a similar way to the password. However, since the second authentication code updates after the authentication expiration time, the possibility that an account is hijacked can be reduced.

By this way, the authentication method with a higher security than only password and more convenience than that with smart card and card reader can be realized. The two-factor authentication has become spread considerably compared to the smart card even though not overall.

### (Phishing)

However, the security with the two-factor authentication is still incomplete. It is known that the two-factor authentication can be easily broken with a method called phishing.

In concrete, a communication device in user's hand is connected to a server in some communication line wired or wireless. The said communication line constitutes a part of the internet. If a user requests an access permission to a server by inputting user account information (user ID, etc.) via a communication terminal, then the server requests the user input an authentication information such as passwords (simply password hereinafter) via the communication terminal. The user inputs a password via the communication terminal and then the communication terminal transfers the password to the server. The server further requests the user inputs a second authentication code (Authenticator) on the communication terminal. For example, the user can retrieve this authentication code from some external device. However, an authentication expiration time (for example 3 minutes) is set up with the retrieved second authentication code having been retrieved like this.

There is a problem here, as mentioned above, “In the present time that the WiFi and the internet have spread, a user does not know where a server to which the user tries to access is physically located. In most cases, none wants to know it. Furthermore, not only the user but also the server's administrator does not know how the connection between the server and the communication terminal in the user's hand is physically. In most cases, none wants to know it.” That is, the importance of the physical existence of the server has been degraded.

That is, the user watches only the screen displayed on the communication terminal in his hand when he communicates with the server. It is what the server instructs the communication terminal of the user to display and what the user recognizes as “website” on the display. That is, the server with its importance of the physical existence having been degraded is the website from the viewpoint of the user. What server requests the user to input the user ID on and what receives the input of the user ID are the website that the server instructs the communication terminal of the user to display. What server requests the user to input the password linked to the user ID on and what receives the input of the password are the website that the server instructs the communication terminal of the user to display. What server requires the user to input the second authentication code on and what receives the second authentication code are the website that the server instructs the communication terminal of the user to display.

By this way, the authentication information that the user inputs on the website, for example, the user ID, the password, the second authentication code, etc. are exposed on the internet wired and wireless, and transferred to a “predetermined” server via the internet wired and wireless, while the physical existence of the “predetermined” server is ambiguous.

At last, the essence of the problem is being unveiled. To protect the authentication information (user ID, password, the second authentication, etc.) that is exposed to the internet wired or wireless, we can adopt various security technologies such as VPN, encryption, digital signature, or blockchain, etc. as well as the authentication expiration time. However, all those technologies assume that the users input the authentication information on a regular website.

That is, another method is necessary to check whether the website displayed on the user's communication terminal is what a server to which the said user aims to access really displays on the user's communication terminal.

In concrete, a hacker makes himself appear to perform a periodical maintenance and sends an email with a fake link to a user (a regular account holder). The regular account holder clicks the link according to the instructions in the email to be conducted to a fake website. The regular account holder inputs the regular authentication information (user ID, password, the second authentication code, etc.) into the fake website. The hacker enters the regular website within the authentication expiration period of the second authentication code. He makes himself appear as the regular account holder to access (log-in) the aimed server using the regular authentication information. After accessing, he can change the password to hijack the regular account. Next, he scans a two-dimensional code using an authentication application which has been installed in his smart phone to synchronize his authentication application. He can get the authority to always access the aimed server as the regular user after that. This is called phishing.

By this way, it is difficult to avoid the phishing even though the two-factor authentication is effective, unless the user sufficiently careful. However, to be careful, to be inconvenient.

FIG. 1 is a drawing to illustrate an example of the correlation between security and convenience. The security is to be reinforced in the ordering of a system protocol with only password (Password), that with password and two-factor authentication (Password & TFA), and that appended with smart card (Password, TFA & smartcard). However, the convenience is suppressed with respect to this ordering.

Furthermore, as the number of accounts (Accounts #) that are held by one user, that user is forced to manage plural passwords. It is not always possible for all users to make all passwords surely under their management. In this event, even using the system protocol (or simply system) with only password, the password management may get complicated considering the periodical change of passwords, and hence the convenience may be suppressed. Additionally, since an old password is likely to be a security hole, the security may be also suppressed as the number of accounts increases. The numbers of accounts and passwords are increasing annually in the trend as users more use the internet for working or private. That is, the authentication with only passwords, which has been deemed as convenient, is going to be complicated and inconvenient indeed.

The essence of the problem is that authentication information such as passwords, etc. is exposed to the internet. Moreover, even using the application of the two-factor authentication is helpless to the phishing attack, as mentioned above.

In consideration of such a situation, new authentication technologies like biometrics authentication, etc. are expected to be spread for the authentication using passwords. Examples are face authentication and fingerprint authentication in smart phones. Smart phones are infrastructure having been spread already. The merit of this method is to make us free from carrying an additional security device. If it is unnecessary to remember passwords, then it may get furthermore convenient. It may be unnecessary to worry if a password having been carelessly stored somewhere is leaked.

In concrete, a communication device in user's hand is connected to a server in some communication line wired or wireless. The said communication line constitutes a part of the internet. A user has a communication terminal (for example, smart phone, etc.). A regular administrator of the server delivers a predetermined application. The user installs this application to his smart phone to generate an account on this application. The server registers this account. This application has a public key in advance. The secret key to this public key is stored in the server. When the user registers his account, the server instructs the user to input his biometrics authentication via his communication terminal. As an example, the application installed in the communication terminal generates a biometrics authentication code from the user's face using a camera installed on the communication terminal. Or as another example, the application generates a biometrics authentication code from the user's fingerprint by the user's touching a touch panel of the communication terminal. Or to generate a biometrics authentication, the user can use a biometric sensor in addition to the communication terminal by connecting it to the communication terminal. Biometric sensors like this are used to sense the user's biometrics authentication to generate the biometrics authentication code. The biometric sensors are connected to the communication terminal in some connection line such as Bluetooth (trade name), USB, LAN, WiFi, etc. and hence can transfer information relating to the biometrics authentication code to the communication terminal. The communication terminal generates a biometric encryption code by encrypting the biometrics authentication code having been generated from the biometrics authentication by this way with the said public key. Or it is also possible for the biometric sensor to generate a biometric encryption code from the biometrics authentication code with the said public key. In this event, the biometric sensor provides the biometrics encryption code to the communication terminal. In any way, the communication terminal transfers this biometric encryption code to the server via the internet. The server can decrypt the received biometric encryption code with the said private key to securely receive and store the biometrics authentication code having been generated from the biometrics authentication that the user's communication terminal had retrieved.

There is a risk that the biometrics authentication code is leaked by hacking, if the communication terminal stores authentication information such as the biometrics authentication code, etc., having been generated from the biometrics authentication. Hence, it is not preferable to store biometrics authentication code in a communication terminal or biometric sensor, which has a limited security resource. It is preferable to delete any data relating to the biometrics authentication that the communication device or the biometric sensor has treated with just after the usage.

After registering an account, when the user opens this application, that is, the user signs in the account using the communication terminal, the communication terminal (or the application) automatically requests the access permission to the server. The server requests the user to input a biometrics authentication via the communication terminal. As an example, the application installed in the communication terminal generates a biometrics authentication code from the user's face using a camera installed on the communication terminal. Or as another example, the application generates a biometrics authentication code from the user's fingerprint by the user's touching a touch panel of the communication terminal. Or as another example, it is possible to generate a biometrics authentication code from data that a biometric sensor sensed. The communication terminal generates a biometric encryption code by encrypting the biometrics authentication code having been generated from the biometrics authentication with the said public key. The communication terminal transfers this biometric encryption code to the server via the internet. The server decrypts the received biometric encryption code with the said private key and then receives the biometrics authentication code. The server compares it with the stored biometric encryption code. If they are regarded as matched, then access is permitted.

It appears that both convenience and security can be improved by using biometrics authentication indeed. However, there is still a vulnerability of phishing.

For example, a hacker can develop an application for phishing (phishing application) to distribute it on the internet. This hacker, furthermore, can manage a server for hacking (hacking server). A user installs this hacking application to his communication terminal (for example, his smart phone) and then generates an account on this application. The hacking server keeps registering this account. This application has a public key in advance. The secret key to this public key is stored in the hacking server. When the user registers his account, the hacking server instructs the user to input his biometrics authentication via his communication terminal. As an example, the application installed in the communication terminal generates a biometrics authentication code from the user's face using a camera installed on the communication terminal. Or as another example, the application generates a biometrics authentication code from the user's fingerprint by the user's touching a touch panel of the communication terminal. Or, further, in another example, the biometrics authentication code can be generated from data that a biometric sensor retrieved. The communication terminal generates a biometric encryption code by encrypting the biometrics authentication code having been generated from the biometrics authentication by this way with the said public key. The communication terminal transfers this biometric encryption code to the hacking server via the internet. The hacking server can decrypt the received biometric encryption code with the said private key and then can store the biometrics authentication code having been generated from the user's biometrics authentication. By this way, the hacker can steal the regular user's biometrics authentication code.

Next, a hacker can steal account information (user ID, password, etc.) from a regular user with the conventional phishing attack. In concrete, a hacker makes himself appear to perform a periodical maintenance and sends an email with a fake link to the regular. The link to open the hacking site is attached to the email. Unless the user is careful, he opens the link to be conducted to the hacking site. According to the instruction therein, he inputs his user ID, his password, and the two-factor authentication thereon, and then the account information (user ID and password, etc.) can be stolen.

Moreover, the hacker can install an application, which the regular server has distributed, to his own communication terminal (for example, his smart phone, etc.). Then, using the biometrics authentication code that he stolen by the above-mentioned method as well as the regular user's authentication information (user ID, password, two-factor authentication, etc.) on this application, he can impersonate the regular user to access the regular server.

FIG. 2 is a drawing to illustrate an example of the basic configuration of the above-mentioned method of the conventional online authentication (communication authentication or, simply, authentication).

The user has a communication terminal, and hence he can input authentication data relating to the online authentication such as user-ID, password, two-factor authentication (TFA) and biometrics authentication, etc. to this communication terminal via the interface of the communication terminal. It is preferable not to use an additional security device (Add Sec. Dev.) like smart card because it suppresses convenience. Instead, it has been believed preferable to use two-factor authentication (TFA) or biometrics authentication. Taking into consideration the convenience, it is preferable that the communication terminals have the functions of two-factor authentication or biometrics authentication. Recent smart phones have already adopted such functions.

It has been believed that this communication terminal can access the server via the internet to securely transfer authentication data that the user input to the communication device to the server by using technologies such as encryption, virtual private network (VPN), digital signature, etc.

However, as mentioned above, what the user inputs authentication information (user ID, password, two-factor authentication, biometrics authentication, etc.) to is the interface (Website) that the server instructs the communication terminal to show on the display of the communication terminal. If this website is the hacking site that the hacker set up for phishing, then the hacker can steal encrypted authentication information even though it was encrypted, even though VPN protected the communication not to be intercepted, and even though a digital signature was attached.

For this encryption, conventional public key encryption may be used. That is, a public key is attached to the application to be installed to the communication terminal. Hence, the communication has been believed safe, even though encrypted authentication code is stolen, unless the secret key is stolen.

However, the hacker distributes public key by distributing a hacking application, as mentioned above. The authentication information was encrypted using this public key. The encrypted authentication information that the hacker received can be decrypted using the private key that the hacker originally owns. By this way, the hacker can steal the plain text of the authentication code.

The bottom cause of the vulnerability to phishing is based on the basic arrangement of the conventional online authentication. In other words, in conventional authentication, the subject to authenticate is the server and what is to be authenticated is the communication terminals. Even though we excluded the vulnerabilities between the user and the communication terminal using password, using it together with two-factor authentication, or using them together with smart card authentication or biometrics authentication, etc., it is hardly helpful to phishing.

### SUMMARY OF THE INVENTION

### Problem to be Solved by the Invention

The present invention was made in consideration of the above-mentioned situation and aims to provide a system protocol technology for building an online authentication, which is tough to phishing, without using an additional security device and without exposing password to the internet.

### Method to Solve the Problem

The present invention adopts the following arrangements to solve the above-mentioned problems.

The solution that the present invention proposes is characterized by including:
a first electronic device and a second electronic device which are connected to each other on the network, wherein:
a first user to operate the said first electronic device,
the said first electronic device has a first special code,
the said first special code is confined within the said first electronic device,
the said second electronic device has a second special code,
the said second special code is confined within the said second electronic device,
the said first electronic device receives a first input from the said first user, and receives a second input from the said second electronic device, and a second intermediate code is generated using the said first and second inputs and the said first special code,
the said first electronic device sends the said second intermediate code to the said second electronic device,
the second electronic device generates a first comparing code from the said second special code and the said second intermediate code using a third function,
the said first electronic device receives an eleventh input from the said eleventh user, and then a twelfth intermediate code is generated using the said eleventh and second inputs and the said first special code,
the said first electronic device sends the said twelfth intermediate code to the said second electronic device,
the said second electronic device generates an eleventh comparing code from the said second special code and the said twelfth intermediate code using the said third function, and then the said eleventh comparing code and the said first comparing code are compared.

The solution that the present invention proposes, furthermore, has the following method, characterized by further having a twenty-first electronic device, wherein:
the twenty-first electronic device has a twenty-first special code,
the said twenty-first special code is confined within the said twenty-first electronic device,
the said twenty-first electronic device receives the said first input from the said first user and the said second input from the said second electronic device, and then a twenty-second intermediate code is generated from the said first and second inputs and the said twenty-first special code,
the said twenty-first electronic device sends the said twenty-second intermediate code to the second electronic device, and
the second electronic device generates a twenty-first comparing code from the said second special code and the said twenty-second intermediate code using the said third function and then compares the said twenty-first comparing code and the said first comparing code.

The method that the present invention proposes further the following method, wherein:
a third intermediate code is generated from the said first input and the said first special code using a fourth function,
the said first electronic device sends the said third intermediate code to the said second electronic device, and then a fourth intermediate code is generated from the said third intermediate code and the said second special code using a fifth function,
the said second electronic device sends the said fourth intermediate code to the said first electronic device, and then a third comparing code is generated from the said fourth intermediate code and the said first special code using a six function.

furthermore, there is a thirty-first electronic device, wherein:
the said thirty-first electronic device has a thirty-first special code,
the said thirty-first special code is confined within the said thirty-first electronic device,
the first electronic device sends the said third intermediate code to the said thirty-first electronic device, and then a fifth intermediate code is generated from the said third intermediate code and the said thirty-first special code using the said fifth function,
the said thirty-first electronic device sends the said fifth intermediate code to the said first electronic device, and then a thirty-first comparing code is generated from the said fifth intermediate code and the said first special code using the sixth function, and
then the said thirty-first comparing code and the said third comparing code are compared.

Below, the best embodiment to realize the invention is described in concrete.

The best embodiment to carry out the invention

As mentioned above, in the present invention, “local authentication code”, which are not exposed on the internet (network) and is to be used only between a user and a regular communication terminal (or communication device, or simply, device) that the user uses, is proposed and then the online authentication method using it is proposed.

Furthermore, by adopting “mutual authentication”, wherein the communication terminal also authenticates the server, the method to reinforce measure to phishing is used together.

Below, we illustrate the invention in concrete using drawings.

### (Three Factors of the Internet)

In general, the online authentication system is composed of three factors (user, communication terminals, and server) on the internet or network. Nevertheless, in the conventional online authentication method, the communication security between the user and the communication terminal and that between the communication terminal and the server have been separately designed. That is, the security between the user and the communication terminal has been designed based on password, two-factor authentication, an additional security device like smart card, etc., and biometrics authentication, etc., whereas the security between the communication terminal and the server has been designed based on encryption, VPN, and digital signature, etc. A correlation between both has the lack of unified technical correlations. It may be regarded as attributable to the difference in the interface. A human interface to manage mutual correlations of human beings and electronic devices between the user and the communication device (camera, speaker, display, touch panel, mouse, keyboard, and various sensors, etc.) is necessary. It is quite different in technology from the interface between the communication device and the server, both of which are electronic devices.

### (Registration of Communication Device)

FIG. 3 is a drawing to illustrate an example of the registration method of a communication terminal (communication device) on the online authentication of the present invention. First, let us consider an online authentication system, which is composed of the user (User-1), a communication device (Device-2) and a server (Server-3). Suppose that necessary applications have been installed in advance in the communication device. Furthermore, a special code (DBC2) has been confined inside (bounded to) the communication device. A special code (SBC3) has been confined inside (bounded to) the server.

A necessary condition in mutual authentication, which is characterized in the present invention, is that there are confined special codes in both a communication device and a server. As in the conventional example that a server identifies a communication device only, the SBC3 was not especially necessary.

To confine (bound) some kind of codes inside a device, it is preferable to terminate an area where the code is stored from the external I/O, or, more strictly speaking, to use a Physically-Unclonable-Function (PUF). Anyway, some sort of processes are necessary to steal the special codes. An example is described below.

(Open appli.) If the user (User-1) opens an application on the communication device (Device-2), then (Request auth) the communication device requests the registration of the communication device to the server (Server-3). In response to this request, the server returns Challenge C0 to the communication device. The communication device separately requests the user to input an authentication code such as password, etc. In response to this request, the user inputs a local authentication code (Local auth code) PL1 to the communication device. Inside the communication device, a synced code SC01 is generated using C0 and PL1. It is preferable to delete C0 in the communication device after generating SC01. The synced code is a code which can be synchronized to another communication device which the user uses.

It is possible to use the function fa to generate the synced code. The said C0 and PL1 are passed to the function as arguments. The value of this function is SC01, which is also an intermediate code. Hence the following equation can be satisfied.

SC01=fa(C0,PL1)

Subsequently, inside the communication device, the response R012 is generated from SC01 and DBC2 using the function fb as arguments. The said SC01 and DBC2 are passed to the fb as arguments. The value of this function is R012, which is also an intermediate code. Hence, the following equation can be satisfied.

R012=fb(SC01,DBC2)

The communication device transfers this R012 to the server. It is preferable to delete R012 in the communication device after that. Inside the server, a comparing code is generated from R012 and SBC3 using the function fc. The said R012 and SBC3 are passed to the fc. The value of this function is a comparing code Q0123. Hence, the following equation can be satisfied.

Q0123=fc(R012,SBC3)

(Store (C0, Q0123)) The server stores C0 and Q0123 in a secure area inside the server. Hence, the registration of the communication device (Device-2) that the regular user (User-1) uses to the server (Server-3) is completed. Here note what the communication device (Device-2) sent to the server is R012 and not PL1. That is, PL1 is a local authentication code, which can be exchanged only between the user (User-1) and the communication device (Device-2).

### (Authentication of User)

FIG. 4 is a drawing to illustrate an example of the authentication method of a user on the online authentication of the present invention. First, let us consider an online authentication system, which is composed of the user (User-1′), a communication device (Device-2) and a server (Server-3).

Suppose that necessary applications have been installed in advance in the communication device. Furthermore, a special code (DBC2) has been confined inside the communication device. A special code (SBC3) has been confined inside the server. Since the explanation of the special code is like that in the registration, it is omitted below.

(Open appli.) If the user opens an application on the communication device, then (Request auth) the communication device requests the authentication of the communication device to the server. In response to this request, the server returns Challenge C0 to the communication device. (Request password) The communication device separately requests the user to input a password. In response to this request, the user inputs a local authentication code (Local auth code) PL1′ to the communication device. Inside the communication device, a synced code SC01′ is generated from C0 and PL1′ using the same function fa at the registration of the communication device. It is preferable to delete C0 in the communication device after generating SC01′. The synced code is a code which can be synchronized to another communication device which the user uses. The said C0 and PL1′ are passed to the function fa as arguments. The value of this function is SC01′, which is also an intermediate code. Hence the following equation can be satisfied.

SC01′=fa(C0,PL1′)

Subsequently, inside the communication device, the response R01′2 is generated from SC01′ and DBC2 using the same function fb at the registration of the communication device. The said SC01′ and DBC2 are passed to the fb as arguments. The value of this function is R01′2, which is also an intermediate code. Hence, the following equation can be satisfied.

R01′2=fb(SC01′,DBC2)

The communication device transfers this R01′2 to the server. It is preferable to delete R01′2 in the communication device after that. Inside the server, a comparing code Q01′23 is generated from R01′2 and SBC3 using the same function fc at the registration of the communication device. The said R01′2 and SBC3 are passed to the fc as arguments. The value of this function is a comparing code Q01′23. Hence, the following equation can be satisfied.

Q01′23=fc(R01′2,SBC3)

(Compare Q01′2 with Q0123) The comparing code Q01′23 having been generated by this way is compared with the comparing code Q0123 having been stored in the server at the registration. If they are matched, this user (User-1′) can be deemed as identical to the regular user (User-1). Hence, (Permitted if Q01′23=Q0123) the access of the user (User-1′) to the server via the communication device (Device-2) can be permitted. Otherwise, this access cannot be permitted. Here note what the communication device (Device-2) sent to the server is R01′2 and not PL1′. That is, PL1′ is a local authentication code (Local auth code), which can be exchanged only between the user (User-1′) and the communication device (Device-2).

### (Authentication of Communication Device)

FIG. 5 is a drawing to illustrate an example of the authentication method of a communication device on the online authentication of the present invention. First, let us consider an online authentication system, which is composed of the user (User-1), a communication device (Device-2′) and a server (Server-3). Suppose that necessary applications have been installed in advance in the communication device. Furthermore, a special code (DBC2′) has been confined inside the communication device. A special code (SBC3) has been confined inside the server. Since the explanation of the special code is like that in the registration, it is omitted below.

(Open appli.) If the user opens an application on the communication device, then (Request auth) the communication device requests the authentication of the communication device to the server. In response to this request, the server returns Challenge C0 to the communication device. (Request password) The communication device separately requests the user to input a password. In response to this request, the user inputs a local authentication code (Local auth code) PL1 to the communication device. Inside the communication device, a synced code SC01 is generated from C0 and PL1 using the same function fa at the registration of the communication device. It is preferable to delete C0 in the communication device after generating SC01. The synced code is a code which can be synchronized to another communication device which the user uses. The said C0 and PL1 are passed to the function fa as arguments. The value of this function is SC01, which is also an intermediate code. Hence the following equation can be satisfied.

SC01=fa(C0,PL1)

Subsequently, inside the communication device, the response R012′ is generated from SC01 and DBC2′ using the same function fb at the registration of the communication device. The said SC01 and DBC2′ are passed to the fb as arguments. The value of this function is R012′, which is also an intermediate code. Hence, the following equation can be satisfied.

R012′=fb(SC01,DBC2′)

The communication device transfers this R012′ to the server. It is preferable to delete R012′ in the communication device after that. Inside the server, a comparing code Q012′3 is generated from R012′ and SBC3 using the same function fc at the registration of the communication device. The said R012′ and SBC3 are passed to the fc as arguments. The value of this function is a comparing code Q012′3. Hence, the following equation can be satisfied.

Q012′3=fc(R012′,SBC3)

(Compare Q012′3 with Q0123) The comparing code Q012′3 having been generated by this way is compared with the comparing code Q0123 having been stored in the server at the registration. If they are regarded as matched, this communication device (Device-2′) can be deemed identical to the regular device (Device-2). Hence, (Permitted if Q012′3=Q0123) access from the communication device (Device-2′) to the server can be permitted. Otherwise, this access cannot be permitted. Here note what the communication device (Device-2) sent to the server is R012′ and not PL1. That is, PL1 is a local authentication code (Local auth code), which can be exchanged only between the user (User-1) and the communication device (Device-2).

### (Authentication of User and Communication Device)

In the server, even though the access is requested before the authentication, sometimes it is unsure if either a user or a communication device is regular. In such a case, the process must be continued while both are unknown as regular or not. The present invention can be feasible enough even in such a case.

FIG. 6 is a drawing to illustrate an example of the authentication method of a user and a communication device on the online authentication of the present invention. First, let us consider an online authentication system, which is composed of the user (User-1′), a communication device (Device-2′) and a server (Server-3). Suppose that necessary applications have been installed in advance in the communication device. Furthermore, a special code (DBC2′) has been confined inside the communication device. A special code (SBC3) has been confined inside the server. Since the explanation of the special code is like that in the registration, it is omitted below.

(Open appli.) If the user opens an application on the communication device, then (Request auth) the communication device requests the authentication of the communication device to the server. In response to this request, the server returns Challenge C0 to the communication device. (Request password) The communication device separately requests the user to input a password. In response to this request, the user inputs a local authentication code (Local auth code) PL1′ to the communication device. Inside the communication device, a synced code SC01′ is generated from C0 and PL1′ using the same function fa at the registration of the communication device. It is preferable to delete C0 in the communication device after that. The synced code is a code which can be synchronized to another communication device which the user uses. The said C0 and PL1′ are passed to the function fa as arguments. The value of this function is SC01′, which is also an intermediate code. Hence the following equation can be satisfied.

SC01′=fa(C0,PL1′)

Subsequently, inside the communication device, the response R01′2′ is generated from SC01′ and DBC2′ using the same function fb at the registration of the communication device. The said SC01′ and DBC2′ are passed to the fb as arguments. The value of this function is R01′2′, which is also an intermediate code. Hence, the following equation can be satisfied.

R01′2′=fb(SC01′,DBC2′)

The communication device transfers this R01′2′ to the server. It is preferable to delete R01′2′ in the communication device after that. Inside the server, a comparing code Q01′2′3 is generated from R01′2′ and SBC3 using the same function fc at the registration of the communication device. The said R01′2′ and SBC3 are passed to the fc as arguments. The value of this function is a comparing code Q01′2′3. Hence, the following equation can be satisfied.

Q01′2′3=fc(R01′2′,SBC3)

(Compare Q01′2′3 with Q0123) The comparing code Q01′2′3 having been generated by this way is compared with the comparing code Q0123 having been stored in the server at the registration. If they are regarded as matched, this user (User-2′) and the communication device (Device-2′) can be deemed identical to the regular user (User-2) and the regular device (Device-2), respectively. Hence, (Permitted if Q01′2′3=Q0123) access of the user (User-1′) to the server via the communication device (Device-2′) can be permitted. Otherwise, this access cannot be permitted. Here note what the communication device (Device-2) sent to the server is R01′2′ and not PL1′. That is, PL1′ is a local authentication code (Local auth code), which can be exchanged only between the user (User-1′) and the communication device (Device-2′).

### (Special Code)

As mentioned above, theft of a special code can be a cause of the vulnerability of the system. Hence, we explain a method to avoid theft of a special code using a device identification module (Device Identification module).

FIG. 7 is a drawing to illustrate an example of the method to avoid theft of a special code.

The device identification module is a device to receive an input CX, have an inner code DX, and output an output RX. The inner code is a code specific to a communication terminal or communication hardware like server, which has the said device identification module, and can be realized using PUF, etc. For example, if the said communication terminal is Dvice-2, then the inner code is DX2. The said server is Server-3, and then the inner code is DX3. While Device-2 and Server-3 are different hardware, DX2 and DX3 are different codes even though they received a common input CX. Of course, Device-2 and Server-3 can receive different inputs from each other (for example, CX2 and CX3, which are different from each other). In general, let us consider a function fd to generate RX using an inner code DX and an input CX. That is, the following equation can be satisfied.

RX=fd(CX,DX)

PUF is also an example of embodiment to satisfy the function of fd. In the case that the device identification module is installed into the communication device (Device-2), the input CX is given from the external (External Entity) of the device identification module. In general, the external entity like this can be anything which can connect to the communication device (Device-2). In one case this connection is an eternal connection, in the other case this connection is a temporary connection. For example, the external entity of the device identification module that is installed to the communication device (Device-2) is the server (Server-3), the user (User-1), the communication device (Device-2), and what relates to the maintenance and the management of the communication device (Device-2), or a third entity, etc. Anyway, the output RX can take the role of the special code DBC2. And then, after generating RX, it is preferable to delete the received input CX in the communication device (Device-2). Because it may be unable to confine (bound) the special code to the communication device if CX as well as DX is stolen by a hacker.

In the case that the device identification module is installed into the server (Server-3), the input CX can be given from the external entity (External Entity) of the device identification module. In general, the external entity like this can be anything which can connect to the server (Server-3). In one case this connection is an eternal connection, in the other case this connection is a temporary connection. For example, the external entity of the device identification module that is installed to the server (Server-3) is the communication device (Device-2), the user (User-1), what relates to the maintenance and the management of the server (Server-3), or a third embodiment, etc. Anyway, the output RX can take the role of the special code SBC3. And then, after generating RX, it may be preferable to delete the received input CX in the server (Server-3). Because it may be unable to confine (bound) the special code to the server if CX as well as DX is stolen by a hacker.

Suppose that a hacker succeeded in stealing DX using some method. At this moment, DX is not confined inside a communication device or a server. However, even though a hacker succeeded in stealing DX, DX is not a special code. It is unable to reproduce a special code from DX unless knowing an input CX. Accordingly, it may be able in operation to confine (bound) a special code to a communication device or a server using this method. Furthermore, it may be able to update a special code by changing CX. That is, a special code can be updated from the external at the convenience of the system administrator. It is preferable to update a special code at the time of the server maintenance or the software update at the communication device. Furthermore, when updating a special code, it is preferable to perform the registration of a communication device or a server again.

### (Measure to Phishing)

As mentioned above, the bottom cause of the vulnerability to phishing is based on the basic arrangement of conventional online authentication. In other words, in conventional authentication, the subject to authenticate is the server and what is to be authenticated is the communication terminals or the user. Even though we excluded the vulnerabilities between the user and the communication terminal using password, using it together with two-factor authentication, or using them together with smart card authentication, or biometrics authentication, etc., it is hardly helpful to phishing.

### (Registration of Server)

The present invention was made in consideration of the above-mentioned situation. The present invention adopts a mutual authentication system protocol, in which not only a server authenticates a communication terminal (communication device) but a communication terminal (communication device) also authenticates the server.

In the mutual authentication system of the present invention, a special code SBC3 has been confined inside a server in advance so that a communication device (Device-2) can authenticate a server (Server-3). FIG. 8 is a drawing to illustrate an example of the registration of the server in the mutual authentication that the present invention adopts.

First, let us consider an online authentication system, which is composed of the user (User-1), a communication device (Device-2) and a server (Server-3). Suppose that necessary applications have been installed in advance in the communication device. Furthermore, a special code (DBC2) has been confined inside the communication device. A special code (SBC3) has been confined inside the server.

(Instruction with “local” password (PL1)) User (User-1) can send a local authentication code (Local auth code) PL1 to a communication device (Device-2) and can also instruct the Device-2 to register a server (Server-3). Inside the communication device (Device-2), the intermediate code C12 is generated from the received PL1 and the special code DBC2 using the function fe. The said PL1 and DBC2 are passed to the fe as arguments. The value of this function is C12. Hence, the following equation can be satisfied.

C12=fe(PL1,DBC2)

The communication device (Device-2) transfers this C12 to the server (Server-3) as a challenge. The server (Server-3) receives the C12 as an input, and then generates the response R123 from the said C12 and SBC3 using a function ff. The said C12 and SBC3 are passed to the ff as arguments. The value of this function is R123, which is also an intermediate code. Hence, the following equation can be satisfied.

R123=ff(C12,SBC3)

The server (Server-3) responds R123 to the communication device (Device-2) as a response. In the communication device (Device-2), a comparing code Q123 is generated from this R123 and DBC2 using a function fg. The said R123 and DBC2 are passed to the fg as arguments. The value of this function is a comparing code Q123. Hence, the following equation can be satisfied.

Q123=fg(R123,DBC2)

Or C12 can be used as an argument for DBC2 regarding a system specification. In this case, the following equation can be also used.

Q123=fg(R123,C12)

Anyway, the communication device (Device-2) must store this Q123 in as a safe area as possible inside. In the case that both the server to which the regular user (User-1) accesses and the communication device with which the user uses to access the server are uniquely determined, neither PL1 nor C12 is necessary to be stored inside the communication device (Device-2). It is preferable to delete both PL1 and C12 after the usage inside the communication device. In the case that both PL1 and C12 are stored as a set, a common communication device can be used for plural accounts. Or plural servers can be registered in a communication device by changing local authentication code (Local auth code) for each server to be accessed. In FIG. 8, an example of how to store PL1 and Q123 as a set is explained. (Store (PL1, Q123)). That is, Store (PL1, Q123) can be replaced by Store (C12, Q123) or Store (Q123). Anyway, at least Q123 must be stored in the communication device (Device-2).

It is preferable to delete R123 in the server (Server-3) after sending it. By this way, the registration of the server (Server-3) that the regular user (User-1) uses to the communication device (Device-2) is completed. Here note what the communication device (Device-2) sent to the server is C12 and not PL1. That is, PL1 is a local authentication code (Local auth code), which can be exchanged only between the user (User-1) and the communication device (Device-2).

### (Authentication of Server)

FIG. 9 is a drawing to illustrate an example of the server authentication method on the mutual authentication of the present invention.

First, let us consider an online authentication system, which is composed of the user (User-1), a communication device (Device-2) and a server (Server-3′). Suppose that necessary applications have been installed in advance in the communication device. Furthermore, a special code (DBC2) has been confined inside the communication device. A special code (SBC3′) has been confined inside the server.

(Instruction with “local” password (PL1)) The user (User-1) can instruct the communication device (Device-2) to make the authentication test of the server (Server-3′) by sending the local authentication code (Local auth code) PL1 to Device-2. Inside the communication device (Device-2), the intermediate code C12 is generated from the received PL1 and the special code DBC2 using the same function fe at the registration of the server. The said PL1 and DBC2 are passed to the fe as arguments. The value of this function is C12. Hence, the following equation can be satisfied.

C12=fe(PL1,DBC2)

The communication device (Device-2) transfers this C12 to the server (Server-3′) as a challenge. Inside the server (Server-3′), the C12 is received as an input and then a response R123′ is generated from the C12 and SBC3′ using the same function ff at the registration of the server. The said C12 and SBC3′ are passed to the ff as arguments. The value of this function is R123′, which is also an intermediate code. Hence, the following equation can be satisfied.

R123′=ff(C12,SBC3′)

The server (Server-3′) responds R123′ to the communication device (Device-2) as a response. Inside the communication device (Device-2), a comparing code Q123′ is generated from this R123′ and DBC2 using the same function fg at the registration of the server. The said R123′ and DBC2 are passed to the fg as arguments. The value of this function is a comparing code Q123′. Hence, the following equation can be satisfied.

Q123′=fg(R123′,DBC2)

Or C12 can be used as an argument for DBC2 regarding a system specification. In this case, the following equation can be also used.

Q123′=fg(R123′,C12)

Anyway, in the communication device (Device-2), this Q123′ is compared with Q123 having been stored under the management (Compare Q123′ with Q123). If they are deemed as matched, then this server (Server-3′) can be certified to be identical to the regular server (Server-3) (Permitted if Q123′=Q123). In this event, the user (User-1) can be permitted to access the server (Server-3) through the communication device (Device-2). If Q123′ and Q123 are not matched, then this server cannot be deemed identical to the regular server. Any access to this server must be declined. By this way, it can protect the user (User-1) from the phishing attack.

### (Authentication of Server and User)

FIG. 10 is a drawing to illustrate an example of the server authentication method on the mutual authentication that the present invention adopts.

First, let us consider an online authentication system, which is composed of the user (User-1′), a communication device (Device-2) and a server (Server-3′). Suppose that necessary applications have been installed in advance in the communication device. Furthermore, a special code (DBC2) has been confined inside the communication device. A special code (SBC3′) has been confined inside the server.

(Instruction with “local” password (PL1′)) The user (User-1′) can instruct the communication device (Device-2) to make the authentication test of the server (Server-3′) by sending the local authentication code (Local auth code) PL1′ to Device-2. Inside the communication device (Device-2), the intermediate code C1′2 is generated from the received PL1′ and the special code DBC2 using the same function fe at the registration of the server. The said PL1′ and DBC2 are passed to the fe as arguments. The value of this function is the intermediate code C1′2. Hence, the following equation can be satisfied.

C1′2=fe(PL1′,DBC2)

The communication device (Device-2) transfers this C1′2 to the server (Server-3′) as a challenge. Inside the server (Server-3′), the C1′2 is received as an input and then a response R1′23′ is generated from the C1′2 and SBC3′ using the same function ff at the registration of the server. The said C1′2 and SBC3′ are passed to the ff as arguments. The value of this function is R1′23′, which is also an intermediate code. Hence, the following equation can be satisfied.

R1′23′=ff(C1′2,SBC3′)

The server (Server-3′) responds R1′23′ to the communication device (Device-2) as a response. Inside the communication device (Device-2), a comparing code Q1′23′ is generated from this R1′23′ and DBC2 using the same function fg at the registration of the server. The said R1′23′ and DBC2 are passed to the fg as arguments. The value of this function is a comparing code Q1′23′. Hence, the following equation can be satisfied.

Q1′23′=fg(R1′23′,DBC2)

Or C1′2 can be used as an argument for DBC2 regarding a system specification. In this case, the following equation can be also used.

Q1′23′=fg(R1′23′,C12)

Anyway, in the communication device (Device-2), this Q1′23′ is compared with Q123 having been stored under the management (Compare Q1′23′ with Q123). If they are deemed as matched, then this server (Server-3′) can be certified to be identical to the regular server (Server-3) (Permitted if Q1′23′=Q123). In this event, the user (User-1′) can be permitted to access the server (Server-3′) through the communication device (Device-2). If Q1′23′ and Q123 are not matched, then this server cannot be deemed identical to the regular server. Any access to this server must be declined. By this way, it can avoid the phishing attack.

### (Local Auth Code)

The local authentication code (Local auth code) can be exchanged only between a user and a communication device. Accordingly, if the local authentication code (Local Auth Code) is a password, then it is a local password. Or a local authentication code (Local Auth Code) is an authentication code which can be generated based on information of user's biometrics information (face, fingerprint, vein pattern, iris, sonagram, etc.) and speech information, which a communication terminal (Device-2 or Device-2′) can scanned, and can be exchanged only between a user and a communication terminal. Or a local authentication code (Local Auth Code) is an authentication code which can be generated from some living body information (barcodes, 2-dimensional codes, images for authentication, video for authentication, etc.) retrieved from the external using a sensor for scanning image information, etc., audio information and numerical information, etc., and can be exchanged only between a sensor and a communication terminal. Or a local authentication code (Local Auth Code) is an authentication code which can be generated from authentication data having been stored in an external storage or card, etc. in advance, and can be exchanged only between the said external storage or card, etc. and a communication terminal. The local authentication code (Local Auth Code) is not to be exposed on the internet, as illustrated in FIGS. 3-6 and 8-10.

### (Mutual Authentication)

First, to perform the mutual authentication that is characterized in the present invention, mutual registration is necessary. The mutual registration is characterized by being composed of the local authentication code (Local Auth Code) as mentioned above, the registration of the server (Server-3) by the communication device (Devie-2), as shown in FIG. 8, and the registration of the communication device (Device-2) by the server (Server-3), as shown in FIG. 3. FIG. 11 is a drawing to illustrate an example of the mutual registration that is characterized in the present invention. Two kinds of local authentication codes (PL1a, PL1b) are adopted. It can be approved that these two are identical (PL1a=PL1b). (PL1a, Q123) is stored in the communication terminal (Device-2) (Store (PL1a, Q123). As mentioned above, what is stored in the communication terminal (Device-2) can be also (C12, Q123) or only Q123. The other details are omitted because they are self-evident from the explanations of FIGS. 3 and 8. Hence, after the mutual registration, we may carry out the authentication test of the user (User-1′) and the communication terminal (Device-2′) using methods as explained in FIGS. 4 to 6 for example. Or, by a method as explained in FIG. 10 for example, we may carry out the authentication text of the server (Server-3′).

### (Authentication Device)

If using the construction of the present invention, we can propose an authentication device (Authenticator) which can replace the two-factor authenticator. FIG. 12 is a drawing to illustrate an example of the characteristic method of the present invention.

In the view of a server to be accessed, a user and a communication device to access for the user are objects which must be tested for their authentication.

Hence, let us consider an online authentication system, which is composed of the user (User-1′), the communication device (Device-2′), and the authentication server (Server-3). Suppose that necessary applications have been installed in advance in the communication device. Furthermore, a special code (DBC2) has been confined inside the communication device. In the server, there is a special code (SBC3) which has been confined inside. However, the synced code SC01′ has been registered in the device (Device-2′) in advance. The regular comparing code Q0123 has been registered in the server (Server-3).

First, (Request access via terminal) the user (User-1′) requests an access to the server (Server-3) via another communication terminal (Terminal, omitted from the drawing). In response to this, (Request authentication number (AN) via terminal as Challenge) the server (Server-3) requests the user the authentication number (AN) via the communication terminal (Terminal). (Open authenticator) The user (User-1′) opens the authentication application on the communication device (Device-2′).

In the communication device (Device-2′), the response R01′2′ is generated from SC01′ and DBC2′ using the function fh. Hence, the following equation can be satisfied.

R012=fh(SC01′,DBC2′)

The user (User-1′) can send this R01′2′ as the authentication number (AN) to the server (Server-3) by injecting this communication device (Device-2′) to the communication terminal (Terminal). That is, regarding AN as the challenge (Challenge) from the server (Server-3) to the user (User-1′), the R01′2′ can be regarded as the response (Response) from the user (User-1′) to the server (Server-3).

In the server (Server-3), the comparing code Q01′2′3 is generated from this R01′2′ and SBC3 using the function fi. The said R01′2′ and SBC3 are passed to the fi as arguments. The value of this function is the comparing code Q01′2′3. Hence, the following equation can be satisfied.

Q01′2′3=fi(R01′2′,SBC3)

(Compare Q01′2′3 with Q0123) In the server (Server-3), the Q01′2′3 is compared with the regular comparing code Q0123 having been registered in advance. (Permitted if Q01′2′3=Q0123) If they are matched, then the user (User-1′) can be permitted to access the server (Server-3).

Furthermore, though the synced code (SC01, SC01′, etc.) were generated in the communication device in the above-mentioned embodiment, the omission of these synced codes does not deviate from the range of the claims of the present invention. For example, a response (R012, R01′2, R012′, R01′2′, etc.) may be generated from a local authentication code (PL1, PL1′, PL1a, PL1b, etc.), a challenge (C0, etc.) and a special code (DBC2, DBC2′, etc.) using a function fj. In this event, PL (the generic name of local authentication code), C (the generic name of challenge), and DBC (the generic name of special code) are passed to the fj as arguments. The value of this function is the response (R012 as its generic name). Hence, the following equation can be satisfied.

R012=fj(PL,C,DBC)

### (Usage of Special Code)

FIG. 13 is a drawing to illustrate an example of the special code of the present invention.

Device (Device-2) has the device identification module (Device Identification module) with the inner code (DX2) inside. The device (Device-2) receives the challenge (CX1) from the external entity (External Entity-1) and then forwards it to the device identification module embedded inside. In the device identification module, the special code (DBC2) is generated using the DX2 and CX1. For example, these DX2 and CX1 are forwarded to the function fd as arguments to generate the function value RX12. The device (Device-2) can adopt this RX12 as DBC2. Or this RX12 can be regarded as an intermediate code, from which a code converted adequately can be adopted as DBC2. In general, anything that can connect to the communication device (Device-2) can be the external entity (External Entity-1). In one case this connection is an eternal connection, in the other case this connection is a temporary connection. For example, the external entity (External Entity-1) is what relates to the maintenance and management of the server (Server-3), the user (User-1), the communication device (Device-2), or a third entity, etc.

Server (Server-3) has the device identification module (Device Identification module) with the inner code (DX3) inside. The server (Server-3) receives the challenge (CX4) from the external entity (External Entity-4) and then forwards it to the device identification module embedded inside. In the device identification module, the special code (DBC3) is generated using the DX3 and CX4. For example, this DX3 and this CX4 are forwarded to the function fd as arguments to generate the function value RX43. The server (Server-3) can adopt this RX43 as DBC3. Or this RX43 can be regarded as an intermediate code, from which a code converted adequately can be adopted as DBC3. In general, anything that can connect to the server (Server-3) can be the external entity (External Entity-4). In one case this connection is an eternal connection, in the other case this connection is a temporary connection. For example, the external entity (External Entity-1) of the device identification module installed in the server (Server-3) is what relates to the maintenance and management of the communication device (Device-3), the user (User-1), the server (Server-3), or a third entity, etc.

It is preferable that inner codes such as the said DX2 and DX3, etc. are generated from physical randomness which is specific to an IC chip composing the device identification module. It is preferable that this physical randomness varies over chips and that the information quantity of this randomness is large enough that the probability for any two chips to have the same inner code is very low.

Or the inner codes such as the said DX2 and DX3 are codes written in an IC chip which composes the device identification module. However, it is preferable that the probability that the inner codes of arbitral different two chips are matched is very low.

Anyway, it is preferable that it is difficult to alter the inner codes such as the said DX2 and DX3 from the external of an IC chip which composes the device identification module.

In the above, we explained using the functions fa, fb, fc, fd, fe, ff, fg, fh, fi, and fj. Any two of these functions can be identical. Additionally, the arguments and outputs (function value) of the functions from the said fa to fj are some kinds of codes like intermediate codes or comparing codes, etc. For example, such a code is one of local authentication code, challenge, special code, response, intermediate code, input challenge, input, output, inner code, etc. Or it may be approval that a response is an intermediate code. The said function is what can receive an input as an argument and then output a code to be generated after some conversion. It can be realized using software or using hardware.

In addition, the technical range of the present invention is not limited to the above-mentioned embodiments and can be added various kinds of changes without deviating from the purpose of the present invention.

### Applicability of Industry

In the authentication method of the present invention, by confining the authentication codes such as password, etc. inside the user and the communication terminal that the user regularly uses without appending an additional security device such as smart card, etc., the risk of the leak of the authentication code such as password, etc. is suppressed to securely perform connection authentication to a server using an old interface which the user favors. In addition, it can acquire tolerance to phishing attack because of the mutual authentication that a terminal device which the user regularly uses tests the authentication of a server to which the terminal device regularly connects.

### BRIEF DESCRIPTION OF DRAWINGS

FIG. 1 is a drawing to illustrate an example of the correlation of security and convenience.

FIG. 2 is a drawing to illustrate an example of conventional online authentication.

FIG. 3 is a drawing to illustrate an example of the communication device registration method of the present invention.

FIG. 4 is a drawing to illustrate an example of the user authentication method of the present invention.

FIG. 5 is a drawing to illustrate an example of the communication device authentication method of the present invention.

FIG. 6 is a drawing to illustrate an example of the user and communication device authentication method of the present invention.

FIG. 7 is a drawing to illustrate an example of antitheft method of special codes.

FIG. 8 is a drawing to illustrate an example of server registration method in the mutual authentication that the present invention adopts.

FIG. 9 is a drawing to illustrate an example of server authentication method in the mutual authentication that the present invention adopts.

FIG. 10 is a drawing to illustrate an example of server authentication method in the mutual authentication that the present invention adopts.

FIG. 11 is a drawing to illustrate an example of mutual registration method that the present invention adopts.

FIG. 12 is a drawing to illustrate an example of authentication device which is characteristic in the present invention.

FIG. 13 is a drawing to illustrate an example of special codes which relate to the present invention.

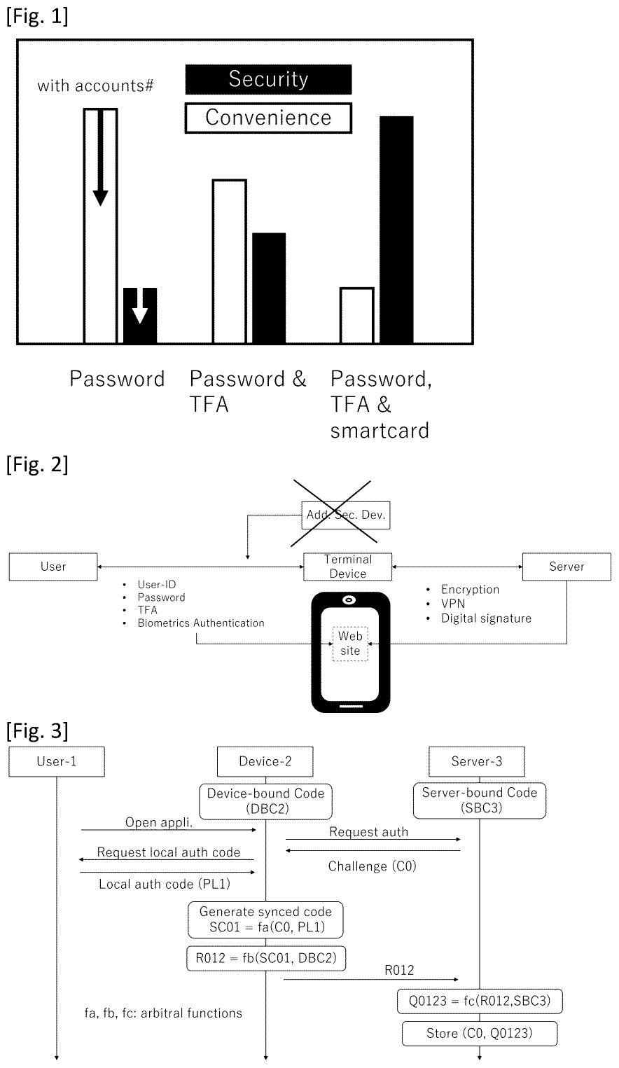

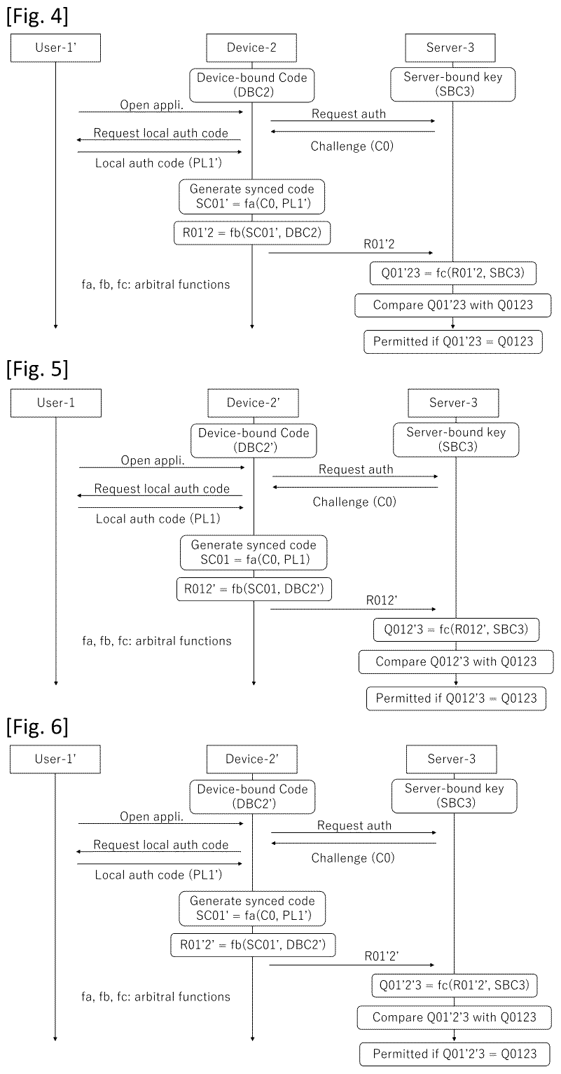

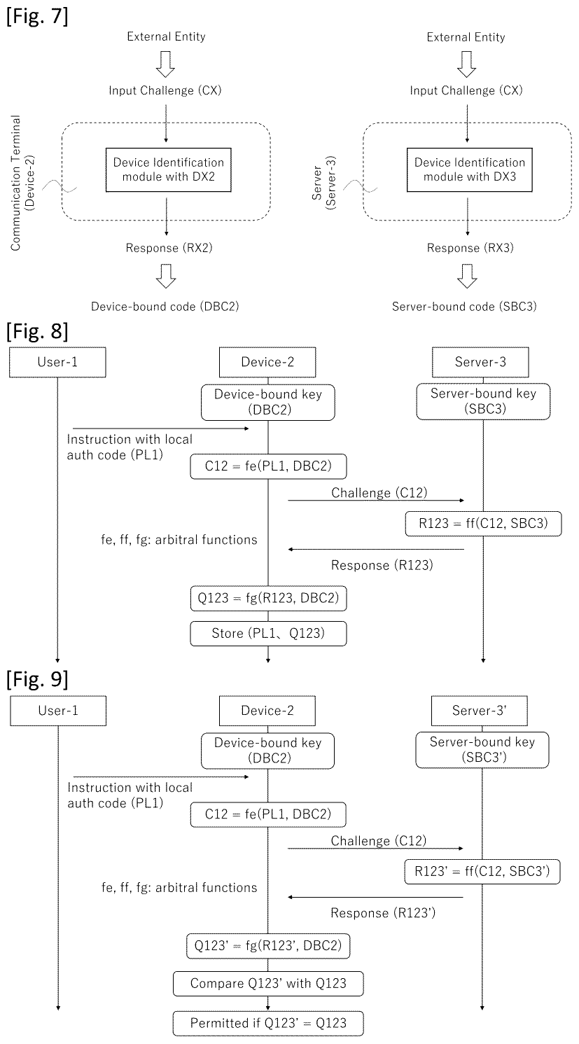

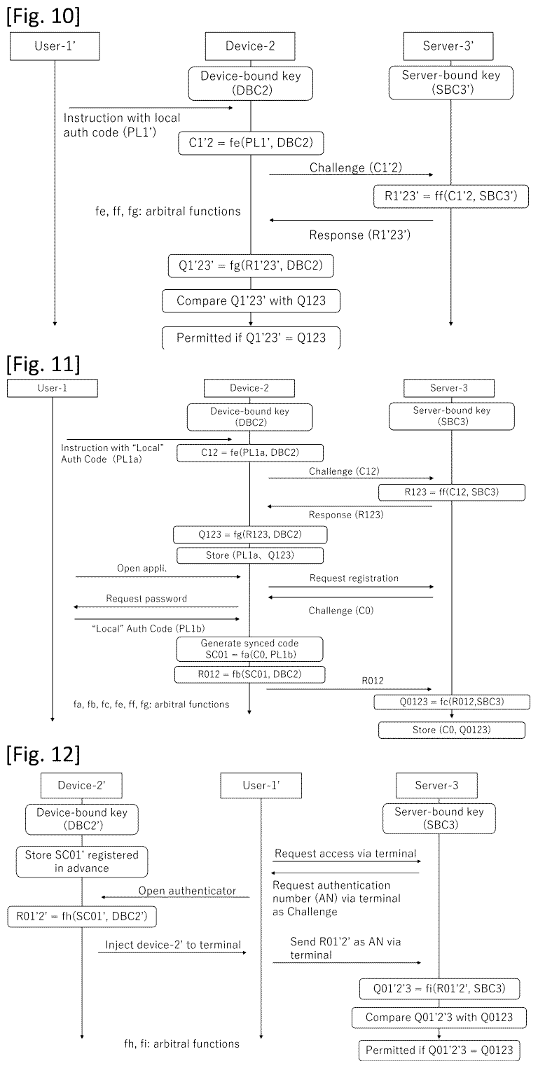

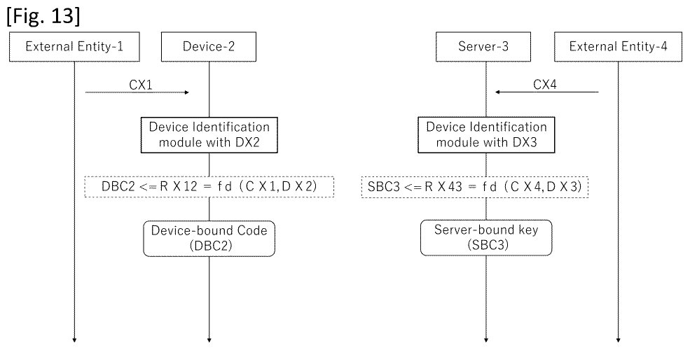

1. An online authentication method, comprising:
a first electronic device and a second electronic device which are connected to each other on a network, wherein:
a first user operates the said first electronic device,
the said first electronic device has a first special code,
the said first special code is confined within the said first electronic device, the said second electronic device has a second special code,
the said second special code is confined within the said second electronic device, the said first electronic device receives a first input from the said first user, and receives a second input from the said second electronic device, and a second intermediate code is generated using the said first and second inputs and the said first special code,
the said first electronic device sends the said second intermediate code to the said second electronic device, and
the second electronic device generates a first comparing code from the said second special code and the said second intermediate code using a third function.

2. The online authentication method according to claim 1, wherein:
a first intermediate code is generated from the said first and second inputs using a first function, and
the said second intermediate code is generated from the said first intermediate code and the first special code using a second function.

3. The online authentication method according to claim 1, which has an eleventh user, wherein:
the said first electronic device receives an eleventh input from the said eleventh user, and then, a twelfth intermediate code is generated using the said eleventh and second inputs and the said first special code,
the said first electronic device sends the said twelfth intermediate code to the said second electronic device,
the said second electronic device generates an eleventh comparing code from the said second special code and the said twelfth intermediate code using the said third function, and then the said eleventh comparing code and the said first comparing code are compared.

4. The online authentication method according to claim 3, wherein:
an eleventh intermediate code is generated from the said eleventh and second inputs using the said first function, and
the said twelfth intermediate code is generated from the said eleventh intermediate code and the said first special code using the said second function.

5. The online authentication method according to claim 1, which has a twenty-first electronic device, wherein:
the twenty-first electronic device has a twenty-first special code,
the said twenty-first special code is confined within the said twenty-first electronic device, the said twenty-first electronic device receives the said first input from the said first user and the said second input from the said second electronic device, and then, a twenty-second intermediate code is generated from the said first and second inputs and the said twenty-first special code,
the said twenty-first electronic device sends the said twenty-second intermediate code to the second electronic device, and
the second electronic device generates a twenty-first comparing code from the said second special code and the said twenty-second intermediate code using the said third function and then compares the said twenty-first comparing code and the said first comparing code.

6. The online authentication method according to claim 5, which has a twenty-first intermediate code generated from the said first and second inputs using the said first function, wherein:
the said twenty-second intermediate code is generated from the said twenty-first intermediate code and the twenty-first special code using the said second function.

7. The online authentication method according to claim 1, wherein:
a third intermediate code is generated from the said first input and the said first special code using a fourth function,
the said first electronic device sends the said third intermediate code to the said second electronic device, and then, in the said second electronic device, a fourth intermediate code is generated from the said third intermediate code and the said second special code using a fifth function, and
the said second electronic device sends the said fourth intermediate code to the said first electronic device, and then, in the said first electronic device, a third comparing code is generated from the said fourth intermediate code and the said first special code using a six function.

8. The online authentication method according to claim 7, which has a thirty-first electronic device on the said network, wherein:
the said thirty-first electronic device has a thirty-first special code,
the said thirty-first special code is confined within the said thirty-first electronic device, the first electronic device sends the said third intermediate code to the said thirty-first electronic device, and then, in the said thirty-first electronic device, a fifth intermediate code is generated from the said third intermediate code and the said thirty-first special code using the said fifth function,
the said thirty-first electronic device sends the said fifth intermediate code to the said first electronic device, and then, in the said first electron device, a thirty-first comparing code is generated from the said fifth intermediate code and the said first special code using the sixth function, and
then the said thirty-first comparing code and the said third comparing code are compared.

9. The online authentication method according to claim 1, wherein:
the said first electronic device has a first device identification module,
the said first device identification module has a first inner code,
a first external entity inputs a first challenge to the said first device identification module, and then the said first special code is generated from the said first challenge and the said first inner code,
the said second electronic device has a second device identification module,
the said second device identification module has a second inner code, and
a second external entity inputs a second challenge to the said second device identification module, and then the said second special code is generated from the said second challenge and the said second inner code.
